(19) United States
(12) Patent Application Publication
(10) Pub. No.: US 2015/0219043 A1
(43) Pub. Date: Aug. 6, 2015

(54) INTERNAL COMBUSTION ENGINE

(71) Applicant: Robert Bosch GmbH, Stuttgart (DE)

(72) Inventors: Udo Schulz, Vaihingen/Enz (DE); Florian Schmitt, Bretten-Sprantal (DE)

(21) Appl. No.: 14/425,362

(22) PCT Filed: Jul. 23, 2013
(86) PCT No.: PCT/EP2013/065500

§ 371 Date: Mar. 3, 2015

(30) Foreign Application Priority Data
Sep. 3, 2012 (DE) 10 2012 215 551.1

(51) Int. Cl. F02G 5/02; F02B 63/04; F02B 63/06; F02B 47/08

(52) U.S. Cl. CPC F02G 5/02; F02B 47/08; F02B 63/04; F02B 63/06

(57) ABSTRACT

The invention relates to an internal combustion engine (1), comprising a fresh gas line (2) and an exhaust gas line (3), wherein a heat exchanger (11) is installed in the exhaust gas line (3), which heat exchanger is a component of a fluid circuit (12), which has at least one expansion device (15) in addition to the heat exchanger (12), which expansion device contains a mechanical output device (17). According to the invention, an internal combustion engine (1) is provided that allows waste heat from the exhaust gas line (3) of the internal combustion engine (1) to be used for a hydraulic system. This is achieved in that the output device (17) is connected to a hydraulic pump (18), which is connected directly or indirectly to a working machine, which is connected to a drive shaft (8) of a motor vehicle, in which the internal combustion engine (1) is installed in order to drive said motor vehicle.

### BACKGROUND OF THE INVENTION

The present invention relates to an internal combustion engine having a fresh gas line and an exhaust gas line, wherein a heat exchanger is installed in the exhaust gas line, which heat exchanger is a component of a fluid circuit which has at least one expansion device in addition to the heat exchanger, which expansion device contains a mechanical output device. The invention furthermore relates to a method for operating an internal combustion engine of this kind

An internal combustion engine of this kind is known from DE 10 2009 028 469 A1. This internal combustion engine has a heat recovery system, which contains a heat exchanger installed in the exhaust gas line. This heat exchanger is part of a fluid circuit which has a pump, an expansion device with a mechanical output device, and a cooler in addition to the heat exchanger. The medium circulating in the fluid circuit, in particular water, is converted to the gaseous state thereof in the heat exchanger by the hot exhaust gases from the internal combustion engine and drives the expansion device. The output device of the expansion device is designed as a shaft, which is connected to a pressure-charging device. The pressure-charging device is designed as an exhaust gas turbocharger, which, as part of the internal combustion engine, conveys additional combustion air in the fresh gas line thereof.

Another internal combustion engine is known from DE 10 2009 024 772 A1. This internal combustion engine has a heat recovery system in which the output device in the expansion device is coupled to a generator. During the operation of the expansion device, the generator produces electrical energy, which is fed to an electric storage device, e.g. in the form of a battery.

### SUMMARY OF THE INVENTION

It is the underlying object of the invention to provide an internal combustion engine which allows effective use of waste heat from the exhaust gas line of the internal combustion engine for a hydraulic system. Moreover, the intention is to specify a suitable method for operating an internal combustion engine of this kind.

This object is achieved by virtue of the fact that the output device of the system is connected to a hydraulic pump in order to use waste heat from the exhaust gas line. The hydraulic pump delivers a hydraulic fluid which can be used in a general form for any desired purposes. The corresponding method for operating the internal combustion engine envisages that a hydraulic accumulator management system controls the charging of a pressure accumulator with hydraulic fluid, which is delivered by a hydraulic pump connected to the output device. The hydraulic fluid can, in turn, be taken from the pressure accumulator for any desired use. This embodiment offers significantly increased and more effectively usable possibilities for exploiting the waste heat of the internal combustion engine than is possible with the prior art described.

As a development of the invention, the hydraulic pump is connected up to a hydraulic pressure accumulator, into which the hydraulic fluid is fed. The stored hydraulic fluid can then, in turn, be taken from the pressure accumulator for any desired use, as required.

As a further development of the invention, the pressure accumulator is a gas bladder accumulator. A gas bladder accumulator has a bladder which is normally filled with nitrogen and is arranged in the accumulator body. If hydraulic fluid is then delivered into the gas bladder accumulator, the gas in the bladder is compressed. The gas volume decreases, with a simultaneous rise in pressure, and thus enables the hydraulic fluid to be stored outside the bladder in the gas bladder accumulator. Conversely, the gas bladder accumulator empties as soon as the pressure on the hydraulic fluid side falls to below the gas pressure. Here, the discharge process is assisted by the compressed gas in the bladder.

As a further development of the invention, the fluid inlet to the pressure accumulator has a shutoff valve. By means of this shutoff valve, the pressure accumulator can be cut out of a fluid line, and the hydraulic fluid can thus be fed directly to a consuming unit, bypassing the pressure accumulator. The advantage of this embodiment lies in increased efficiency by avoiding possible losses due to the storage and removal of hydraulic fluid in or from the pressure accumulator. Moreover, the degree to which the pressure accumulator is charged can be controlled by means of the shutoff valve, which also has a regulating function.

As a further development, the pressure accumulator or the hydraulic pump is connected up directly to a hydraulic machine. The hydraulic machine can, in turn, be used to drive any desired components. On the other hand, however, it is also possible for the hydraulic machine itself to be driven and thus to deliver hydraulic fluid, in particular into the pressure accumulator. This process can be performed in addition or as an alternative to the charging of the pressure accumulator by the hydraulic pump.

As a development of the invention, the hydraulic machine is connected directly or indirectly to a drive shaft of a motor vehicle in which the internal combustion engine is installed in order to drive said motor vehicle. This embodiment represents the preferred embodiment of the invention. In this case, the machine as embodied above can be used as a drive motor which drives the drive shaft of the motor vehicle in addition or as an alternative to a drive provided by the internal combustion engine. Conversely, the machine can be connected as a pump in appropriate driving states (e.g. during braking processes or hill descents by the motor vehicle), thus delivering hydraulic fluid into the pressure accumulator. This embodiment provides a further possibility of charging the pressure accumulator as required and thus supplying the hydraulic machine with hydraulic fluid in a flexible manner and/or at a time decoupled from other processes. This results in new degrees of freedom, hitherto impossible, as regards the shifting of the operating point of the internal combustion engine, especially as regards the engine speed and drive torque, which can be used to optimize fuel consumption behavior, to reduce exhaust emissions and/or to optimize the comfort of operation of the internal combustion engine or of the motor vehicle, for example. These functions complement and optimize hitherto known possibilities in a hydraulic system in which, for example, time-limited, hydraulically assisted driving away and creeping of the motor vehicle, time-limited, hydraulically assisted boosting at maximum load and/or time-limited shifting of the operating point of the internal combustion engine were possible.

As a further development of the invention, a hydraulic accumulator management system is present, which allows or controls the charging of the pressure accumulator by means of the hydraulic pump and/or the charging or discharging of the pressure accumulator by means of the hydraulic machine. This hydraulic accumulator management system can preferably be integrated into an electronic control system of the internal combustion engine. It is thereby possible directly to accept and evaluate operating parameters of the internal combustion engine, for example.

As a further development, the accumulator management system is designed in such a way that it enables the motor vehicle or the internal combustion engine to be boosted, or even enables the operating point of the internal combustion engine to be shifted. In this case, as a further advantageous development of the invention, the accumulator management system is, in turn, set so that a minimum charge of hydraulic fluid is present or is established in the pressure accumulator. This minimum pressure is such that there is, for example, always sufficient capacity for braking energy recovery and, at the same time, that the stored energy in the form of the hydraulic fluid is great enough to allow temporary boosting, for example. In the case of motor vehicles with adaptive route detection of routes already traveled or predictive route planning, e.g. by means of a navigation system, it is possible as an option to infer the brake energy recovery potential and the heat recovery potential of the internal combustion engine over a distance to be traveled. This information can be used to regulate the degree of charge of the hydraulic energy accumulator in the form of the pressure accumulator in such a way that both the energy recovered during braking and the energy recovered by the heat recovery system can be used as fully as possible or in the best way possible over the route. By means of these method steps, the internal combustion engine can be controlled in a significantly more comprehensive and effective way overall.

### BRIEF DESCRIPTION OF THE DRAWINGS

Further advantageous embodiments of the invention can be found in the description of the drawing, in which an illustrative embodiment of the invention shown in the single figure is described in greater detail.

In the drawing:

FIG. 1 shows a schematic circuit diagram of the internal combustion engine with an external fluid circuit for heat recovery from the exhaust gas stream of the internal combustion engine, wherein the fluid circuit has a hydraulic pump, which is connected to a hydraulic hybrid system connected to an output shaft of a motor vehicle in which the internal combustion engine is installed.

### DETAILED DESCRIPTION

An internal combustion engine 1 (shown twice in the circuit diagram for reasons of clarity), which is configured, in particular, as a self-ignition internal combustion engine operated with diesel fuel, has a fresh gas line 2, via which combustion air is fed to the internal combustion engine 1 and compressed in working chambers of the internal combustion engine 1. Fuel is injected into the compressed combustion air, preferably by means of a common rail injection system and burns with the combustion air, moving the pistons of the internal combustion engine 1 to produce a rotary motion of a crankshaft 4 in cylinders of the internal combustion engine. The crankshaft 4 is connected to a transmission 6 by a Cardan shaft and a clutch 5. The transmission 6 has an output shaft 7, which is connected to a drive shaft 8 via a differential 9. The drive shaft 8 is connected to wheels 10, which forms the drive of a motor vehicle in which the internal combustion engine 1 is installed with the components described above. The motor vehicle is of any desired design and can be a passenger vehicle or a commercial vehicle. However, it is also possible for the motor vehicle to be a construction machine or some other machine. The wheels 10 can bring about the locomotion of the motor vehicle directly or indirectly on an appropriate underlying surface. It is also possible to connect two or more drive shafts 8 in a suitable manner to the transmission 6, which can also be designed as an automatic transmission, eliminating the clutch 5.

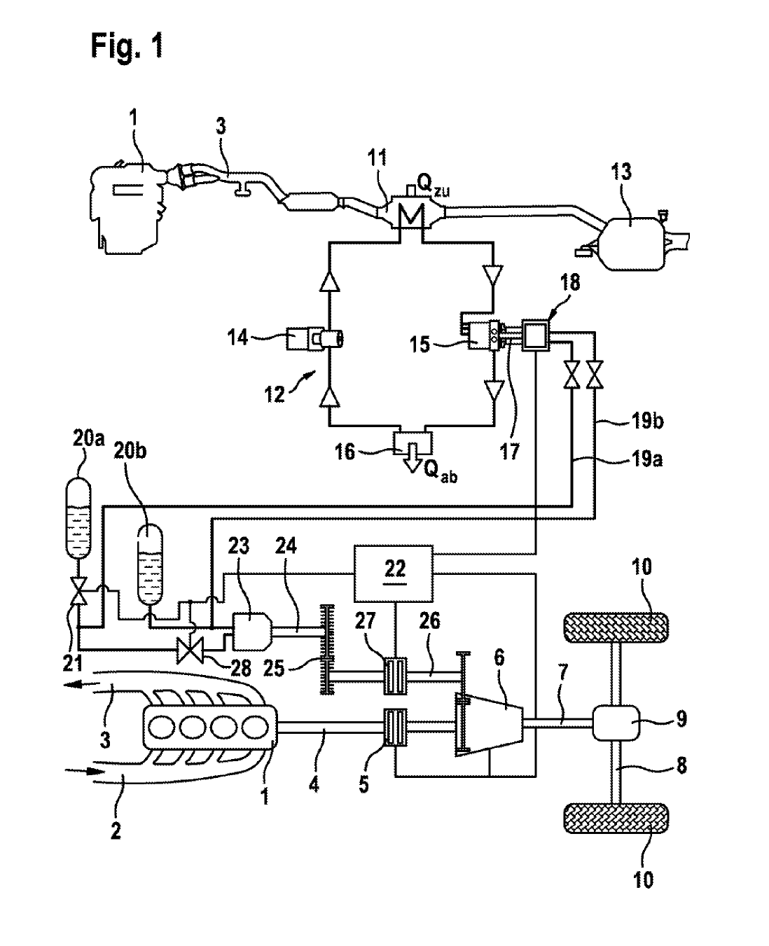

The internal combustion engine 1, which is illustrated once again in isolation in the upper part of FIG. 1 with the complete exhaust gas line 3 attached to enable better illustration of the components to be described, is designed as a four-cylinder internal combustion engine, for example. A turbine of an exhaust gas turbocharger, the compressor of which compresses the combustion air fed in by the fresh gas line 2 to ensure better filling of the combustion chambers of the internal combustion engine 1, is installed in the exhaust gas line 3. A heat exchanger 11, which is part of a fluid circuit 12, is installed in the exhaust gas line 3 downstream of the exhaust gas turbocharger. An exhaust gas aftertreatment device 13, which consists of a catalyst and/or of a soot filter for example, is installed downstream of the heat exchanger 11, once again in the exhaust gas line 3.

The fluid circuit 12 is filled with water, for example, which can be provided with additives, as a heat transfer medium. The heat transfer medium is conveyed through the fluid circuit 12 by a pump 14 and, after flowing through the heat exchanger 11, flows into an expansion device 15, which is designed as a turbine for example. In the heat exchanger 11, the water is converted into the vapor phase by the thermal energy of the exhaust gas of the internal combustion engine 1 and at least partially releases the energy absorbed in the heat exchanger 11 by expansion in the expansion device 15. A cooler 16, in which the heat transfer medium is transferred completely to the liquid state of aggregation, is inserted into the fluid circuit 12 downstream of the expansion device 15.

Together with the components described, the fluid circuit 12 forms an exhaust gas recovery system, with the aid of which energy can be recovered from the hot exhaust gas of the internal combustion engine 1. The expansion device 15 has an output device 17, which is preferably designed as a shaft, which is connected to a hydraulic pump 18 for a hydraulic fluid, e.g. hydraulic oil. The hydraulic pump 18 is connected via lines 19a, 19b to a pressure accumulator 20a, which is furthermore preferably designed as a gas bladder accumulator, and to a reservoir 20b. The reservoir 20b is used exclusively to store hydraulic fluid and, in contrast to the pressure accumulator 20a, does not have a gas bladder but only an expansion volume corresponding, for example, to the environment.

In the fluid inlet, the pressure accumulator 20a has a shutoff valve 21, which is managed by an accumulator management system 22. The accumulator management system 22 can furthermore be part of an electronic control system for the internal combustion engine 1. With the shutoff valve 21 closed, the pressure accumulator 20a is shut off from line 19a. On the outlet side, the pressure accumulator 20a and line 19a are connected up via a control valve 28, which is likewise managed by the accumulator management system 22, to a hydraulic machine 23, the working shaft 24 of which is connected via a multiplication gear 25 to a multiplication gear output shaft 26. The multiplication gear output shaft 26 is connected to the transmission 6, with the inclusion of a selector clutch 27 managed by the accumulator management system.

In the heat recovery process, waste heat is removed from the exhaust gas of the internal combustion engine 1 and used to drive the hydraulic pump 18. The hydraulic pump 18 conveys hydraulic fluid into the pressure accumulator 20a. When required, hydraulic fluid is taken either from the pressure accumulator 20a or directly from line 19a via the shutoff valve 21 or via the control valve 28 and fed to the hydraulic machine 23 in order to drive the latter. The hydraulic machine 23 then introduces additional energy or power into the transmission 6 via the working shaft 24 in addition to the power introduced into the transmission via the crankshaft 4. This additional energy or power can be used, for example, for hydraulically assisted boosting and/or continuous shifting of the operating point of the internal combustion engine 1.

Conversely, it is possible, in the case of an initiated braking process or hill descent of the vehicle, for power or energy to be introduced into the working shaft 24 by the wheels 10 via the transmission 6, the multiplication gear output shaft 26 and the multiplication gear 25 and into the hydraulic machine 23, which then acts as a pump and likewise conveys hydraulic fluid into the pressure accumulator 20a in addition or as an alternative to the hydraulic pump 18.

1. An internal combustion engine (1) having a fresh gas line (2) and an exhaust gas line (3), wherein a heat exchanger (11) is installed in the exhaust gas line (3), which heat exchanger is a component of a fluid circuit (12) which has at least one expansion device (15) in addition to the heat exchanger, which expansion device contains a mechanical output device (17), characterized in that the output device (17) is connected to a hydraulic pump (18).

2. The internal combustion engine (1) as claimed in claim 1, characterized in that the hydraulic pump (18) is connected up to a hydraulic pressure accumulator (20a).

3. The internal combustion engine (1) as claimed in claim 2, characterized in that the pressure accumulator (20a) is a gas bladder accumulator.

4. The internal combustion engine (1) as claimed in claim 2, characterized in that a fluid inlet to the pressure accumulator (20a) has a shutoff valve (21).

5. The internal combustion engine (1) as claimed in claim 2, characterized in that the pressure accumulator (20a) is connected up to a hydraulic machine (23).

6. The internal combustion engine (1) as claimed in claim 5, characterized in that the hydraulic machine (23) is connected directly or indirectly to a drive shaft (8) of a motor vehicle in which the internal combustion engine (1) is installed in order to drive said motor vehicle.

7. The internal combustion engine (1) as claimed in claim 1, further comprising a hydraulic accumulator management system (22), which controls at least one of charging of the pressure accumulator (20a) by means of the hydraulic pump (18) and charging or discharging of the pressure accumulator (20a) by means of the hydraulic machine (23).

8. The internal combustion engine (1) as claimed in claim 7, characterized in that the accumulator management system (22) enables the motor vehicle or the internal combustion engine (1) to be boosted.

9. The internal combustion engine (1) as claimed in claim 7, characterized in that the accumulator management system (22) enables an operating point of the internal combustion engine (1) to be shifted.

10. The internal combustion engine (1) as claimed in claim 7, characterized in that the accumulator management system (22) is set so that a minimum charge of hydraulic fluid is present in the pressure accumulator (20a).

11. A method for operating an internal combustion engine (1) having a fresh gas line (2) and an exhaust gas line (3), wherein a heat exchanger (11) is installed in the exhaust gas line (3), which heat exchanger is a component of a fluid circuit (12) which has at least one expansion device (15) in addition to the heat exchanger (11), which expansion device contains a mechanical output device (17), the method comprising using a hydraulic accumulator management system (22) to control the charging of a pressure accumulator (20a) with hydraulic fluid, which is delivered by a hydraulic pump (18) connected to the output device (17).

12. The method as claimed in claim 11, characterized in that the accumulator management system (22) controls at least one of charging and discharging of the pressure accumulator (20a) by means of a hydraulic machine (23), which is connected directly or indirectly to a drive shaft (8) of a motor vehicle, in which the internal combustion engine (1) is installed in order to drive said motor vehicle.
